(19) United States
(12) Patent Application Publication
(10) Pub. No.: US 2015/0066618 A1
(43) Pub. Date: Mar. 5, 2015

(54) Method and system for providing discounts to consumers

(71) Applicant: James Thomas, Tullahoma, TN (US)

(72) Inventor: James Thomas, Tullahoma, TN (US)

(21) Appl. No.: 14/018,994

(22) Filed: Sep. 5, 2013

(51) Int. Cl. G06Q 30/02

(52) U.S. Cl. CPC G06Q 30/0222
USPC 705/14.23

(57) ABSTRACT

A method is disclosed for issuing rewards to consumers. An embodiment of an inventive method includes presenting product advertisements for reward products to consumers. Consumers view product advertisements and select the reward eligible products they want to purchase. Consumers find those products on store shelves and place them in their shopping cart. After checkout, consumers take a digital photo of their selected reward eligible products. The consumer then sends the digital photo, with their contact information to a remote web server. After the digital photo has been authenticated, rewards shall be issued to consumers contact information and/or credentials by an administrator.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO A SEQUENCE LISTING, A TABLE, OR A COMPUTER PROGRAM, LISTING COMPACT DISC APPENDIX

Not Applicable

### BACKGROUND OF THE INVENTION

1. Field of the Invention

The method and system provided by the invention relate to a method and system for providing a discount to consumers. In particular, the inventive method and system relates to a method for providing discounts to a consumer that takes a digital image of discount eligible products and transmits that image to a remote server with a text message that includes a unique hash tag.

2. Description of the Related Art

Providing a discount on a product is a valid method of increasing sales, increasing brand and product visibility and expanding the market for the product.

Thus, there is a continuing need for methods and systems for providing discounts to consumers that transmit a digital image to a remote web server with a text message that includes a unique hash tag.

Thus, methods for providing discounts are needed which impose a low cost to the product supplier. In addition, methods for providing discounts are needed which allow-a consumer to engage with product brands by taking a digital image of discount eligible products and transmitting the digital image to a remote web server to receive discounts on discount eligible products purchased from retailers.

U.S. Pat. No. 8,239,260 to Lavin, et al. is directed to methods and systems for delivering a discount using a virtual currency The Lavin, et al. patent does not address how a consumer can engage with product brands by taking a photo of discount eligible products to receive discounts on products purchased from retailers.

### BRIEF SUMMARY OF THE PRESENT INVENTION

A method and system for providing discounts to consumers according to an embodiment of the invention it includes the steps of presenting a consumer with product advertisements that promote discount eligible products, the advertisements include a unique hash tag that changes at least once every 24 hours. After viewing the advertisements with the unique hash tag, consumers make a note of the current hash tag and select the discount eligible products they want to purchase. The consumer finds those products on retail store shelves and places them in their shopping cart for purchase. The consumer segregates the discount eligible products from non-eligible products and takes a digital image of their selected products with a digital camera or smartphone while the products are placed on the retail store checkout counter. The consumer then transmits the digital image to a remote web server with a text message that includes the current hash tag. The digital image is then discovered on the remote web server by an administrator and is inspected and authenticated. After the products have been scanned, and the digital image has been authenticated by observing the correct hash tag included in the message, the discounts shall be issued to consumers. The administrator presents the authenticated digital image to retailers, clients and/or product suppliers as validation of services provided. The administrator is the creator of the services and charges the retailers, clients and/or the product suppliers for services provided.

### BRIEF DESCRIPTION OF THE DRAWINGS

FIG. 1 is a drawing illustrating relationships between various participants in an embodiment of an inventive method and system.

### DETAILED DESCRIPTION OF THE INVENTION

A method and system for providing discounts to consumers is provided. In particular, a method and system for presenting product images and providing discounts to a consumer while maintaining the perception of product value in the public view.

Further, a method and system for providing discounts to consumers is described which impose a low cost to the product provider.

For example, an embodiment of an inventive method and system broadly includes providing a webpage; the webpage includes digital images of product advertisements for products that are eligible for discounts. The advertisements include a unique hash tag. After viewing the advertisements, consumers make a note of the hash tag and select the discount eligible products they want to purchase. The consumer finds those products on retail store shelves and places them in their shopping cart for purchase. The consumer segregates the discount eligible products from non-eligible products and takes a digital image of their selected products with a digital camera or smartphone while the products are placed on the retail store checkout counter. The consumer then transmits the digital image to a remote web server with a text message that includes the unique hash tag. After products are scanned and photo is authenticated, the discounts shall be issued to consumers. The digital image is discovered on the remote web server by an administrator and is inspected and authenticated. The administrator presents the authenticated digital image to retailers, clients and/or product suppliers as validation of services provided. The administrator is the creator of the services and charges the retailers, clients and/or the product suppliers for services provided.

In describing the inventive method and system, the term ‘administrator’ as used herein is intended to mean an entity that creates the services. The administrator authenticates digital images of discount-eligible products transmitted by consumers to a remote web server, said administrator may also issue a discount value to consumers for the discount-eligible products purchased, and said administrator further administers relationships with retailers, clients and suppliers.

The term ‘consumer or consumers’ as used herein is intended to mean an individual shopper who purchases discount-eligible products and transmits a photo of said discount-eligible products to a remote web server with a text message that includes a unique hash tag to get a discount on discount eligible products provided by retailers.

The term ‘Remote Web Server’ as used herein is intended to mean a computer web server connected to the Internet that sends and receives digital files to and from consumers. The Remote Web Server is used as a means to communicate with consumers and for consumers to transmit digital files and/or digital images to the administrator.

The term ‘client’ as used herein is intended to mean the one who ‘pays’ for the services. The client may also be termed a “client” of the administrator. Generally, the client and administrator have a relationship, such as customer/service provider.

The term ‘supplier’ as used herein is intended to mean one who ‘pays’ for the services and discounts and who provides a product or service for which a discount/savings value is provided. In general, the supplier is an entity directly involved in supplying the product, such as a manufacturer.

The term ‘retailers’ as used herein is intended to mean one who ‘pays’ for the services and discounts and who provides a product for which a discount/savings value is provided. Retailers are an entity that issues a discount/savings value to consumers for the discount-eligible products purchased.

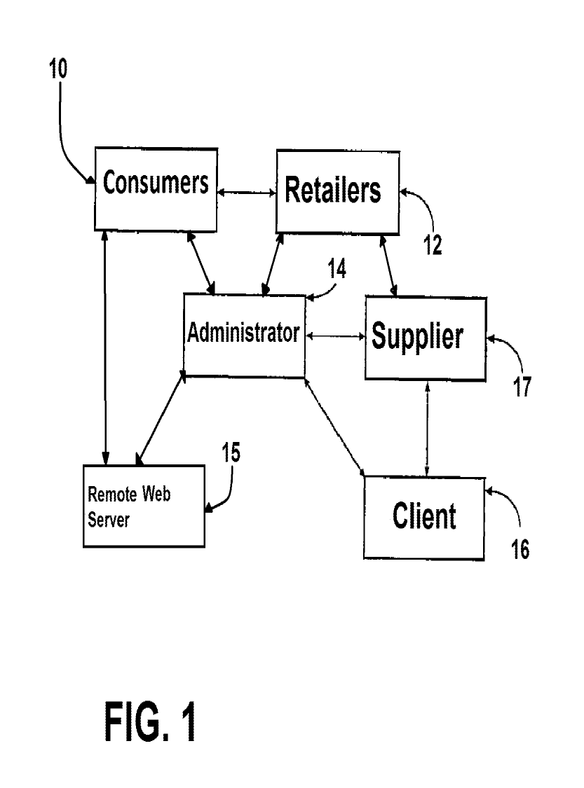

A method and system for providing a discount to consumers is described herein. FIG. 1 depicts relationships between various participants in an embodiment of an inventive method. In a particular embodiment, the Consumers 10 and Retailers 12 preferably have a relationship such as customer/product provider. The Retailers 12 provide a discount to the Consumers 10 for purchasing certain discount eligible products. The Consumers 10, the Remote Server 15 and the Administrator 14 preferably have a relationship such as customer/service provider in which the Remote Server 15 provides a means for the Consumers 10 to transfer digital photographs to the Administrator 14. In a preferred embodiment, the Retailers 12 and the Supplier 17 have a relationship such as customer/product supplier and determine pre-defined value amounts and terms for product discounts. The Client 16 and/or the Supplier 17 have a relationship with the Administrator 14 such as customer/service provider and pay the Administrator 14 to provide services to promote products, the Client 16 and the Supplier 17 preferably have a relationship such as service provider/client whereby the Supplier 17 pays the Client 16 for services to promote products. In another preferred embodiment, the Retailers 12 and the Administrator 14 have a relationship such as customer/service provider and the Retailers 12 pays the Administrator 14 to promote products and inspect, authenticate and provide digital images taken by the Consumers 10 to the Retailers 12 as validation of services provided. The Supplier 17 and the Administrator 14 have a relationship such as customer/service provider and the Supplier 17 pays the Administrator 14 to promote products and inspect, authenticate and provide digital images taken by the Consumers 10 to the Supplier 17 as validation of services provided.

One skilled in the art will readily appreciate that the present invention is well adapted to carry out the objects and obtain the ends and advantages mentioned, as well as those inherent therein. The methods described herein of preferred embodiments, are not intended as limitations on the scope of the invention. Changes therein and other uses will occur to those skilled in the art. Such changes and other uses can be made without departing from the scope of the invention as set forth in the claims.

1. A method for issuing rewards to consumers, comprising the steps of: (a) a consumer selects at least one advertised reward eligible product and purchases it at a retail store checkout and receives a paper sales receipt; (b) after checkout said consumer using a web-enabled device snaps at least one digital photo of their reward eligible products with their front labels facing outward that includes the consumers paper sales receipt showing the date of sale placed among the reward eligible products; (c) said consumer sends said digital photo of their reward eligible products with front labels facing outward and their paper sales receipt to a remote web server; (d) said consumer receives a reward by an administrator who issues an electronic payment, credit/refund or gift card to a consumer's contact information and/or credentials for sending a digital photo of their reward eligible products with front labels facing outward with their paper sales receipt to a remote web server.

2-11. (canceled)
